(19) United States
(12) Patent Application Publication
(10) Pub. No.: US 2019/0296574 A1
(43) Pub. Date: Sep. 26, 2019

(54) COMPUTING SYSTEM WITH EXTERNAL WIRELESS CHARGING COIL

(71) Applicant: INTEL CORPORATION, Santa Clara, CA (US)

(72) Inventors: Hong W. WONG, Portland, OR (US); Wah Yiu KWON, Beaverton, OR (US); Shaorong ZHOU, Shanghai (CN); Anand S. KONANUR, Sunnyvale, CA (US); Songnan YANG, San Jose, CA (US)

(21) Appl. No.: 16/305,864

(22) PCT Filed: Jun. 30, 2016
(86) PCT No.: PCT/CN2016/087840

§ 371 Date: Nov. 29, 2018

(51) Int. Cl. H02J 7/02; H02J 50/10

(52) U.S. Cl. CPC H02J 7/025; H02J 50/10

(57) ABSTRACT

A computing system (100) with external wireless charging coil (150,550,650,750,850), includes a computing apparatus which includes a battery (120,210,320); and the external charging coil (150,550,650,750,850) to be coupled with the computing apparatus, including a self-coiling cable to transition to an uncoiled state when weighted and to transition to a coiled state when unweighted; wherein the battery (120,210,320) is chargeable by inductive charging utilizing the external charging coil (150,550,650,750,850) as an inductive receiving coil.

### TECHNICAL FIELD

Embodiments described herein generally relate to the field of electronic devices and, more particularly, a computing system with external wireless charging coil.

### BACKGROUND

The reduction in size for of electronic devices has all allowed for the construction of systems with significant capabilities in very small packages. In response, new uses for very small form factor systems have been developed.

For certain potential uses, particularly in wearable electronic devices, a very thin structure may be needed before the device is practicable as a product because the bulk of the device is very noticeable by the end user.

However, there are certain current limitations in minimizing the thickness of a computing device. In particular, the charging of the battery in a small form factor computing device presents a challenge because any charging element that is placed within the chassis of such a device will significantly increase the overall thickness of the device.

### BRIEF DESCRIPTION OF THE DRAWINGS

Embodiments described here illustrated by way of example, and not by way of limitation, in the figures of the accompanying drawings in which like reference numerals refer to similar elements.

FIG. 1 is an illustration of a computing system including a card PC and external charging coil according to an embodiment;

FIG. 2 is an illustration of components of a card PC according to an embodiment;

FIG. 3 is an illustration of dimensions of a card PC according to an embodiment.

FIGS. 4A and 4B are illustrations of a lanyard charging coil structure according to an embodiment;

FIGS. 5A, 5B, and 5C are illustrations of a card PC with lanyard charging coil according to an embodiment;

FIG. 6 is an illustration of a vertical charging station for a card PC with external charging coil according to an embodiment;

FIG. 7A is an illustration of a structure of a vertical charging station for a card PC according to an embodiment;

FIG. 7B is an illustration of a structure of a vertical charging station for a card PC with lanyard charging coil according to an embodiment;

FIG. 8 is an lustration of a card PC with lanyard charging coil having coil connector according to an embodiment; and

FIGS. 9A and 9B are illustrations of a horizontal charging station for a card PC with lanyard charging coil.

### DETAILED DESCRIPTION

Embodiments described herein are generally directed to a computing system with external wireless charging coil.

For the purposes of this description:

“Card PC”, “credit card PC”, or “badge PC” refers to a small form factor computing apparatus or system with computing capability. The terms may include, but are not limited to, a computing apparatus or system that is roughly the size of a card badge, commonly worn on a lanyard around the neck of a user, or a credit card.

“Inductive charging” or “wireless charging” refers to process in which an alternating electromagnetic field is generated with a transmitting induction coil to transfer energy through inductive coupling to a receiving induction coil, wherein the receiving device convert the received power into a current for a battery charging process.

“Wearable electronic device” or“wearable” means an electronic device that is integrated at least part into an item that may be worn by a user. Wearable electronics may include electronic devices that operate independently as well as electronic devices that operate in conjunction with a second electronic device, such as a mobile device.

A computing device of the size of a badge or credit card may have many potential uses as wearable electronic devices, including use in the form of an employee badge as the processing ability allows for expanded security functions. A conventional badge may contain an RFID (Radio Frequency Identification) device that generates a radio frequency identification signal in response to the transmitted signal of an RFID reader (or interrogator), which may commonly be a passive element without battery that is activated by the signal of the reader but may also include an active element with a battery source. However, such conventional device is limited to simple identification functions.

Thus, in the design of credit card PC (personal computer) or badge PC, there is a need to provide battery charging function while minimizing apparatus thickness to avoid interfering with user experience as the thickness of such a device is very noticeable to a user. The charging of the battery in such small form factor device presents a particular challenge because, even if the device utilizes wireless charging, the inclusion of a wireless charging coil within a device requires a certain depth, and thus increases the overall thickness of the device. The addition of a wireless charging coil may be expected to cause an overall thickness of the apparatus to increase by 1 to 2 mm in a particular implementation. Further, while the device is being charged, heat will be generated in the charging coil, thus creating a thermal burden for a device including an internal charging coil.

In some embodiments, in order to avoid inclusion of a charging coil within a card or badge PC, the device includes an external charging coil for inductive charging of the battery of the card PC. In some embodiments, the external charging coil comprises a self-coiling cable. In some embodiments, the self-coiling cable may be utilized both as a lanyard when the card PC is worn, the weight of the card PC causing the cable to straighten and transition to an uncoiled state, and as a charging coil, the cable to return to coiled state when the badge PC is in an unweighted state. As described herein, the external charging coil may also be referred to as a lanyard charging coil.

In some embodiments, the external charging coil can be stretched and function as a lanyard when the user is wearing the card PC around the user's neck in the form of an identification badge or other purpose. In some embodiments, the self-coiling nature of the charging coil/lanyard causes the cable to return to the coiled form for support of wireless charging when the user places the coil on or near an inductive charging mat.

In addition, in an embodiment of a device such as a badge PC having an external charging coil that is not embedded in the device, the heat generated in the coil during the charging of the device is outside of the device, thus reducing the burden of thermal design in comparison with a charging coil that is embedded within the a badge PC.

In some embodiments, the external charging coil is coupled to the card PC in a secure fashion, which may include, but is not limited to, a permanent (non-removable) coupling of the external charging coil to the card PC. The charging may optionally include a connector or coupling to allow separation of cable as needed. In some embodiments, the external charging coil may connected a location that is convenient for a user, such a connection in a location or locations that is similar to the connection of a lanyard to a conventional badge or other device.

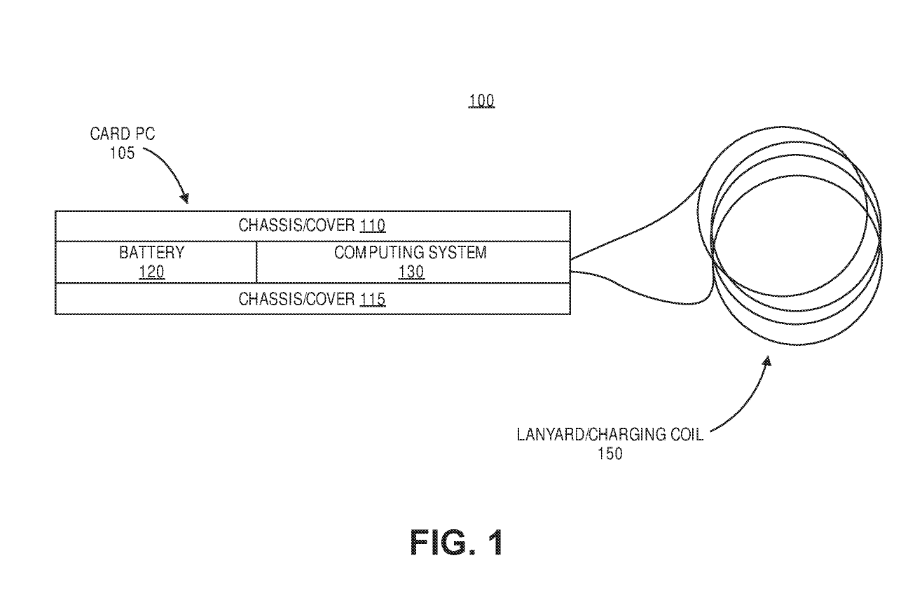

In some embodiments, a computing device such as card PC is coupled with an external self-coiling cable to provide a wireless charging coil for the computing device, such allowing for reduction in the overall thickness of the card PC. A computing device may include, but is not limited to, a device as illustrated in FIGS. 1-3.

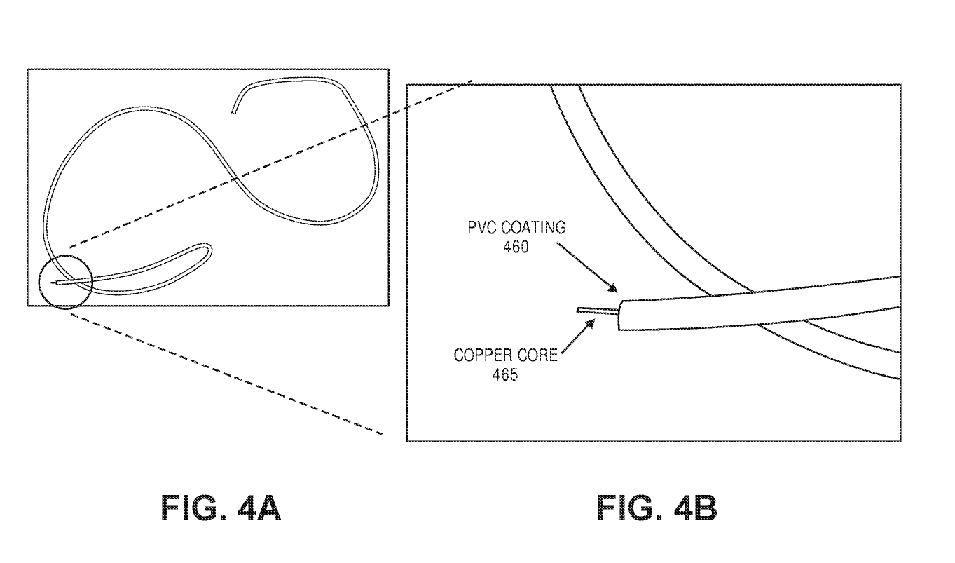

In some embodiments, a self-coiling cable is coupleable with a computing device to provide a low cost combined lanyard and external charging coil for the computing device. An external charging coil may include, but is not limited to, an apparatus as illustrated in FIGS. 4A-5C or 8.

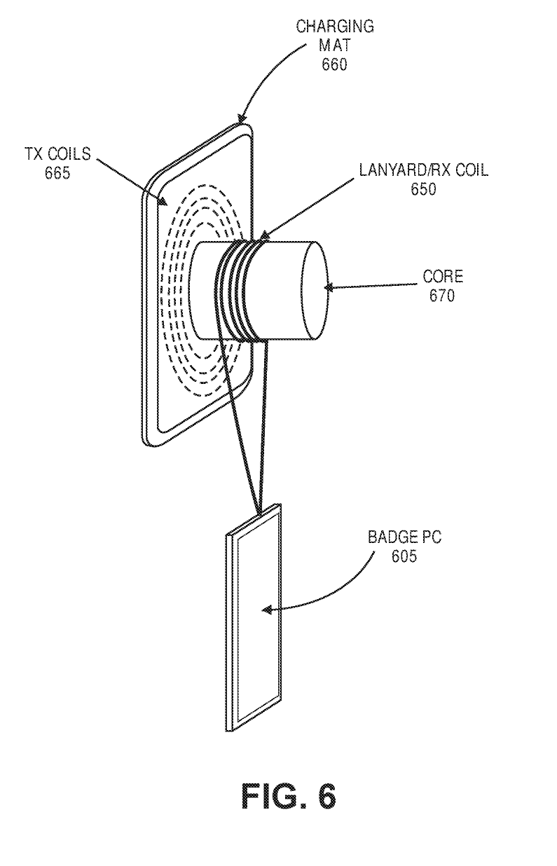

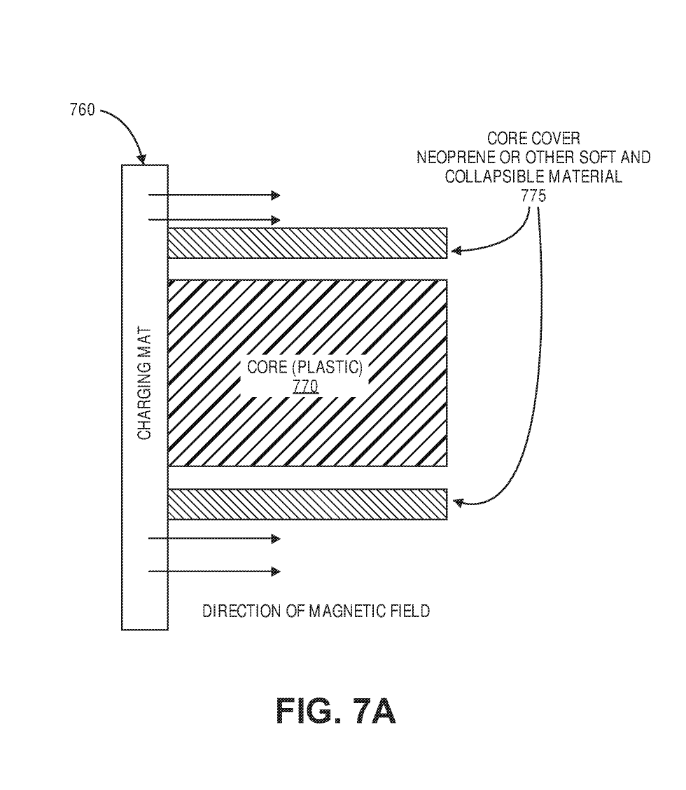

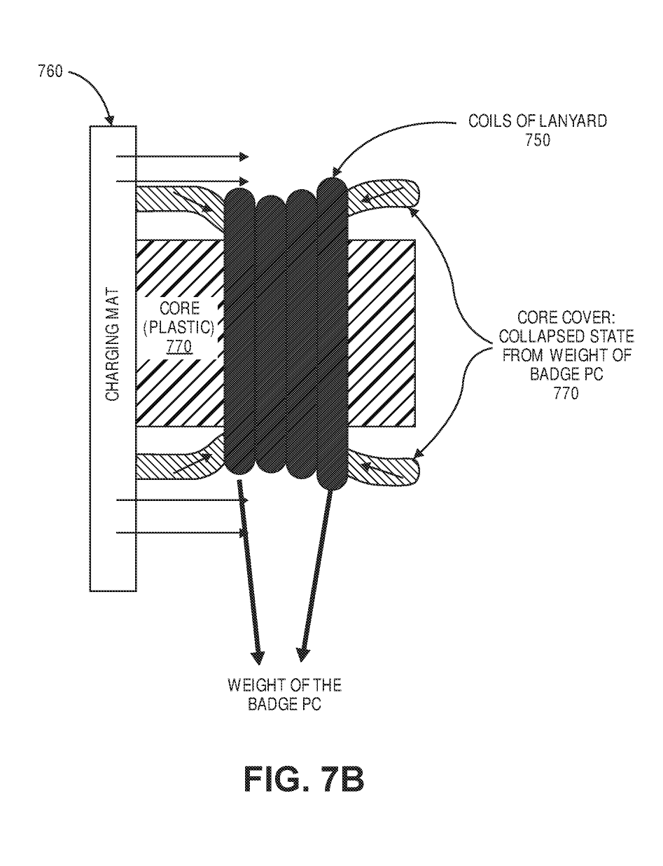

In some embodiments, a charging station or charging mat allows for wirelessly charge of a badge PC by generating an alternating electromagnetic field to generate current flow through the external cable. A charging station or charging mat may include, but is not limited to, an apparatus as illustrated in FIGS. 6, 7A-7B, or 9A-9B.

FIG. 1 is an illustration a computing system including a card PC and external charging coil according to an embodiment. In some embodiments, a card PC 105 is coupled with a lanyard charging coil 150 to form a computing system 100. In some embodiments, the card PC 105 is a wearable electronic device.

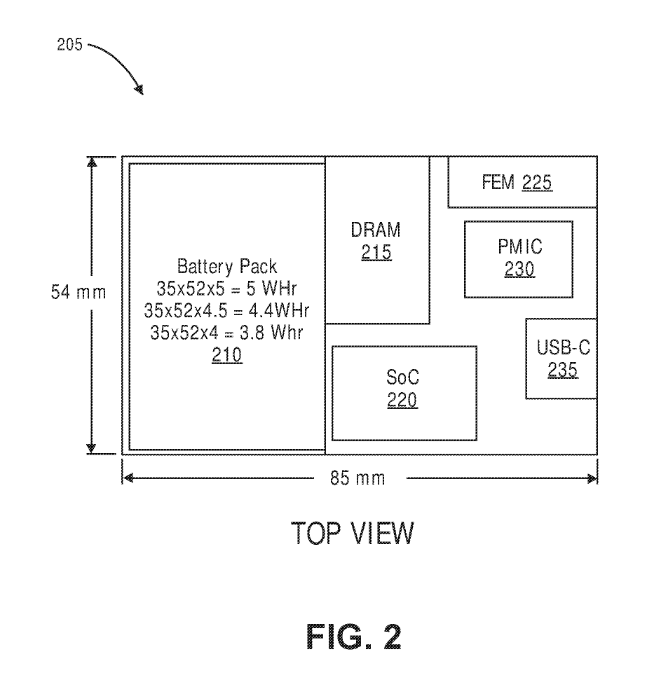

As illustrated in FIG. 1, the card PC 100 may include chassis or cover, illustrated as a first chassis or cover portion 110, which may form a first face of the card PC, and a second chassis or cover portion 115, which may form a second face of the card PC. In this example, the card PC further includes a battery 120 and a computing system 130. Further detail regarding the system components may be found in FIG. 2.

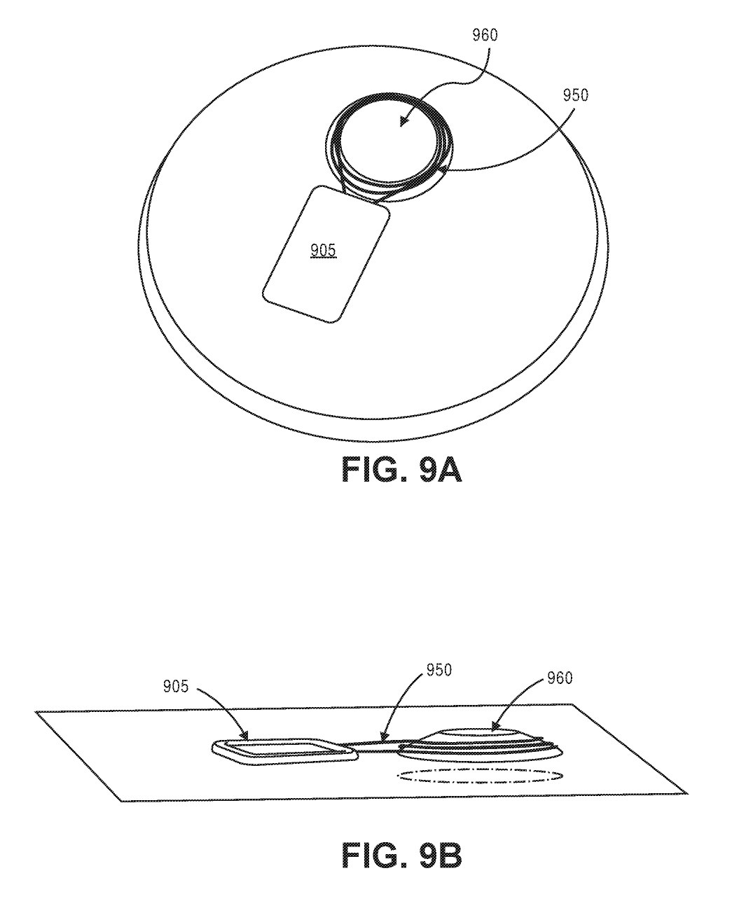

In some embodiments, the card PC 100 is coupled with an external charging coil 150, which is illustrated in FIG. 1 in an unweighted and coiled state. In some embodiments, the battery 105 of the card PC is chargeable utilizing the external charging coil in a charging station, including, for example, a vertical charging station such as illustrated in FIGS. 6, 7A, and 7B or a horizontal charging station such as illustrated in FIGS. 9A and 9B.

FIG. 2 is an illustration of components of a card PC according to an embodiment. FIG. 2 illustrates a top view into a top (or front) face of a card PC 205. In this illustration, the card PC 205 is of a size of approximately 55 mm (millimeters) by 85 mm, but embodiments are not limited to any particular dimensions. In some embodiments, the card PC 205 includes a battery pack 210 that may encompass a large percentage of the overall volume of the card PC. In some embodiments, the card PC 205 utilizes an external charging coil for charging to reduce components for the apparatus, wherein the external charging coil may include a self-coiling charging coil such as the external charging coil 150 illustrated in FIG. 1.

In this illustration, the card PC 205 may include, but is not limited to, a processing element including, for example, a system on chip (SoC) 220. The card PC may further include memory, such as the illustrated dynamic random access memory (DRAM); a front end module (FEM) 225 incorporating one or more wireless technologies, such as WiFi, WWAN (Wireless Wide Area Network), or other wireless systems; and a power management integrated circuit (PMIC) 230 for managing power requirements of the card PC. In some embodiments, the card PC includes one or more electronic connectors, which may include the illustrated USB-C (Universal Serial Bus Type-C) connector 235, wherein the USB-C connector is a compact connector that is particularly suitable for a small processing device.

In some embodiments, the card PC 205 further includes a battery 210 to power the card PC. The size of the battery may vary, but, as illustrated in FIG. 2, dimensions of a common battery 210 may be 35 mm×52 mm×5 mm for a 5.0 WHr (watt hour) battery; 35 mm×52 mm×4.5 mm for a 4.4 WHr battery; and 35 mm×52 mm×4 mm for a 3.8 WHr battery.

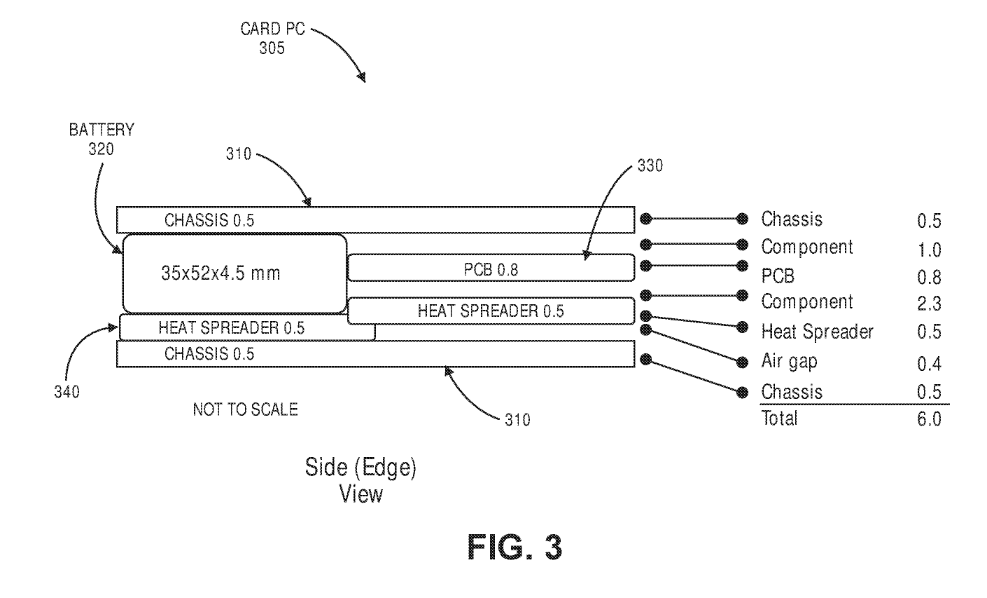

FIG. 3 is an illustration of dimensions of a card PC according to an embodiment. FIG. 3 illustrates a side or edge view of a card PC 305. In this illustration, the card PC 305 includes a top and bottom chassis 310, which may have thickness of 0.5 mm for each component.

In an example, an overall thickness (height) for the card PC 305 may by 6.0 mm. In a particular arrangement, a battery side of the card PC, in addition to the top and bottom chassis 310, there is a battery 320 of 4.5 mm thickness in this example, and a heat spreader 340 of 0.5 mm thickness, for a total thickness of 6.0 mm.

For a component side of the card PC 305 as illustrated in FIG. 3, in addition to the top and bottom chassis 310, the unit may include a printed circuit board (PCB) 330 of thickness 0.8 mm. The PCB 330 includes installed components having certain height, such as, for example, 1.0 mm on a first side of the PCB and 2.3 mm on a second side of the PCB. In some embodiments, the apparatus may further include a heat spreader of 0.5 mm; and an air gap of 0.4, for a total device thickness of 6.0 mm.

In the illustration provided in FIG. 3, the card PC 305 is at a possible maximum reasonable thickness without inclusion of an inductive coil for wireless inductive charging of the card PC. In some embodiments, the card PC 305 may be coupled with an external charging coil to form a computing system, wherein the external charging coil may include a self-coiling charging coil such as the external charging coil 150 illustrated in FIG. 1.

FIGS. 4A and 4B are illustrations of a lanyard charging coil structure according to an embodiment. In some embodiments, a lanyard charging cable, such as the external charging coil 150 illustrated in FIG. 1, is constructed of materials including an insulating exterior (which may be referred to as an exterior insulating cover), such as a PVC (polyvinyl chloride) coating 460 illustrated in FIG. 4B, and a conductive interior (which may be referred to as an interior conductor or cable), such as a copper core 465.

In some embodiments, the copper core 465 is to act as an inductive receiving coil for inductive charging purposes. In some embodiments, the lanyard charging coil is self-coiling such that the cable acts as a charging coil when the cable is an unweighted state, and extends to, for example, act as a lanyard when the cable is in a weighted state.

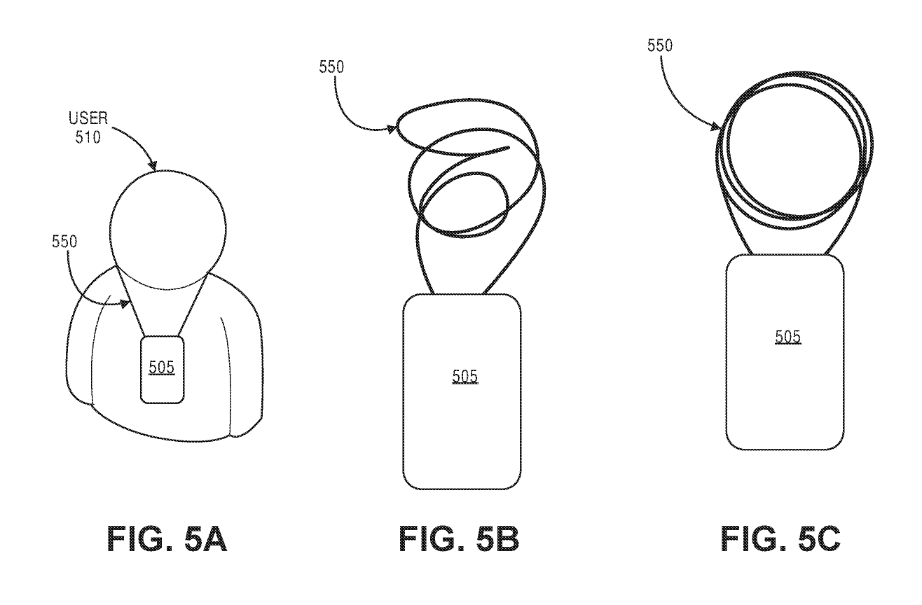

FIGS. 5A, 5B, and 5C are illustrations of a card PC with lanyard charging coil according to an embodiment. In some embodiments, as illustrated in FIG. 5A, a user 500 may utilize a card PC with external charging coil 550 as a badge or other wearable electronic device usage, using the external changing coil as a lanyard for the card PC. As shown in FIG. 5A, the external charging coil 550 is to straighten into a lanyard form in an uncoiled state when the weight of the card PC 505 is applied to the charging coil 550, such that the charging coil appears similar to a conventional lanyard for wearing of the card PC 505 as a badge or identification.

In some embodiments, as illustrated in FIGS. 5B and 5C, the external charging coil 550 attached to the card PC 505 is a self-coiling cable, the charging coil to return to a coiled state when the cable is unweighted, such as when removed from the neck of a user.

FIG. 6 is an illustration of a vertical charging station for a card PC with external charging coil according to an embodiment. In some embodiments, a vertical charging station (referring to a charging station that is mountable in a vertical alignment) includes charging mat portion 650 including inductive power transmission coils 665 and a core 670, the core to provide a charging location for inductive receiving coils. In some embodiments, the core 670 is cylindrical in shape at least in part, and allows for hanging a device by the coils of the charging coil (stated in another way, the wraps or turns of the charging coil when in a self-coiled state) for the purpose of charging the device. The charging station further includes certain power components to drive the power transmission coils for generation of the electromagnetic field, wherein the additional power components are not illustrated in FIG. 6. The power components may include any known power connection, transformer, and other common elements to provide inductive charging.

In some embodiments, an external charging/lanyard coil acts as a inductive receiving coil for inductive charging of a badge PC (card PC) 605. In some embodiments, the external charging coil 650 is a self-coiling cable, wherein the coiling of the charging cable is tightened by the weight of the badge PC 605 to provide for improved charging by creating a more uniform inductive coil for inductive charging, wherein the diameter of the core 670 establishes the diameter of the inductive coils. Further, a user is able to simply hang the coiled charging cable on the core to obtain proper coiling of the cable for charging operation.

FIG. 7A is an illustration of a structure of a vertical charging station for a card PC according to an embodiment. FIG. 7A includes a side view of a vertical charging station. In some embodiments, a vertical charging station includes a charging mat 760 to produce an electromagnetic field outward from the charging mat 760 for charging of a device utilizing a charging coil. In some embodiments, a core 770 is coupled with the charging mat 760, wherein the core may comprise plastic or other solid non-metallic material. In some embodiments, the core 770 is cylindrical in shape at least in part. In some embodiments, the core 770 may further be encompassed by a core cover 775, wherein the core cover may comprise a compressible or collapsible material such as neoprene or other similar material provide improved coiling, as further illustrated in FIG. 7B.

FIG. 7B is an illustration a structure of a vertical charging station for a card PC with lanyard charging coil according to an embodiment. As illustrated in FIG. 7B, upon placing the coils (wraps or turns) of a lanyard charging coil 750 of a badge PC onto the core of the vertical charging station, the weight of the badge PC pulling on the charging coil 750 will cause the core cover 770 to collapse at least in part. The collapsed state of the core cover 770 will then operate to press or push the coils of the charging coil 750 together, thereby improving the form of the coils and enhancing inductive coupling efficiency for charging of the badge PC. In some embodiments, the compressible cover is to press or push a plurality of coils of the charging coil together for a charging operation in response to the hanging weight of the device on the core. In some embodiments, a diameter of the core 770 may be larger at a first end and at a second opposite end of the core than at a location between the first and second ends, such as the core including a tapering of a diameter towards a middle of the core, to further press or push the coils of the charging coil together.

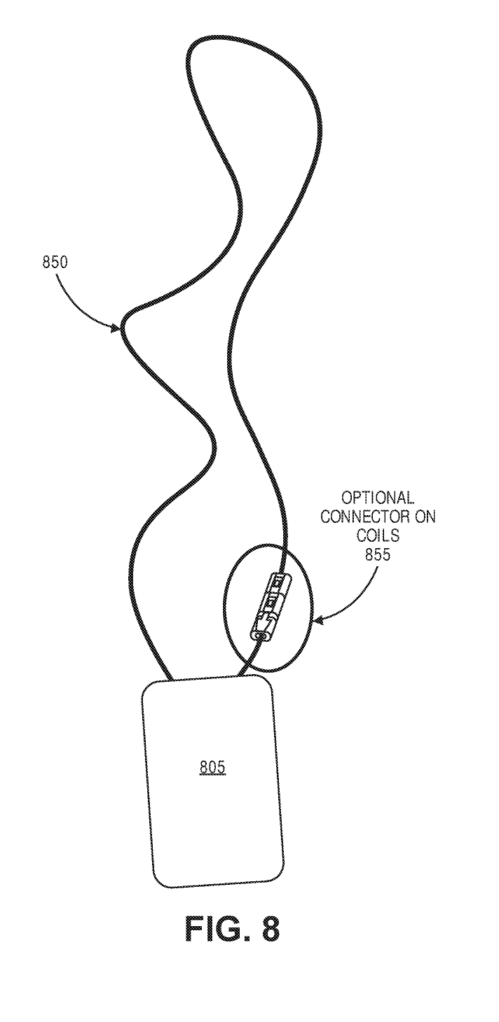

FIG. 8 is an illustration of a card PC with lanyard charging coil haying coil connector according to an embodiment. In some embodiments, the lanyard charging cable 850 of a badge computer 805 may optionally include a connector 855, there allowing the lanyard to be placed around the neck of a user without being required to pull the lanyard over the head of the user, which may be useful for persons with reduced mobility or who require assistance. In some embodiments, the connector 855 includes a conductive link to electrically connect the separated portions of the cable together and allow current flow for inductive charging operation. In another embodiment, the lanyard charging cable 850 may include multiple connectors 855 to allow the removal and replacement of the charging cable for the badge PC 805.

FIGS. 9A and 9B are illustrations of a horizontal charging station for a card PC with lanyard charging coil. In some embodiments, as shown in FIG. 9A, a horizontal charging station (referring to a charging station that is mountable or usable in a horizontal alignment) for a badge PC 905 includes a core 960 for placing the lanyard charging cable 950, the core to assist in shaping the coils of the charging cable 950 for improved charging efficiency. As illustrated in FIG. 9B, the core 960 for the horizontal charging station may be cone shaped at least in part, including sloped sides to allow for the weight of the coil to result in an improved coiling arrangement on the core 960 in a charging location when the badge PC 905 is being charged.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

In some embodiments, a computing system includes a computing apparatus, the computing apparatus including a battery; and an external charging coil to be coupled with the computing apparatus, the external charging coil including a self-coiling cable to transition to an uncoiled state when weighted and to transition to a coiled state when unweighted. In some embodiments, the battery is chargeable by inductive charging utilizing the external charging coil as an inductive receiving coil.

In some embodiments, the external charging coil is usable as a lanyard to suspend the computing apparatus.

In some embodiments, the computing apparatus is a wearable electronic device. In some embodiments, the computing apparatus is a badge PC (personal computer).

In some embodiments, the computing apparatus is to provide one or more security functions.

In some embodiments, the external charging coil includes an exterior insulating cover; and an interior conductor. In some embodiments, exterior insulating cover comprises PVC (polyvinyl chloride). In some embodiments, the interior conductor includes a copper cable.

In some embodiments, the computing apparatus and the external charging coil are permanently coupled together.

In some embodiments, an external charging coil includes an exterior insulating cover; and an interior conductor. In some embodiments, the external charging coil is self-coiling, the charging coil to transition to an uncoiled state when the external charging coil is weighted and to transition to a coiled state when the external charging coil is unweighted.

In some embodiments, the exterior insulating cover comprises PVC (polyvinyl chloride).

In some embodiments, the interior conductor comprises a copper cable.

In some embodiments, the external charging coil is operable as an inductive receiving coil when in the coiled state.

In some embodiments, the external charging coil is operable as a lanyard for support of a device when weighted.

In some embodiments, the external charging coil further includes one or more connectors to connect and disconnect the external charging coil.

In some embodiments, a charging station includes a charging mat portion, the charging mat portion including an inductive transmission coil to generate an electromagnetic field; and a core coupled with the charging mat portion, the core to provide a charging location for an inductive receiving coil.

In some embodiments, the core comprises a solid non-metallic material.

In some embodiments, the core is cylindrical in shape at least in part to hang a device including a self-coiling charging coil for charging of the device.

In some embodiments, the charging station is a vertical charging station.

In some embodiments, the charging station further includes a compressible cover over the core. In some embodiments, the compressible cover is to press a plurality of coils of the charging coil together for a charging operation in response to the hanging weight of the device on the core. In some embodiments, the compressible cover comprises neoprene material.

In some embodiments, a diameter of the core is larger at a first end and at a second opposite second end of the core than at a location between the first end and the second end.

In some embodiments, the core is cone shaped at least in part to place a self-coiling charging coil for charging of a computing device.

In some embodiments, the charging station is a horizontal charging station.

1. A computing system comprising:
a computing apparatus, the computing apparatus including a battery; and
an external charging coil to be coupled with the computing apparatus, the external charging coil including a self-coiling cable to transition to a uncoiled state when weighted and to transition to a coiled state when unweighted;
wherein the battery is chargeable by inductive charging utilizing the external charging coil as an inductive receiving coil.

2. The computing system of claim 1, wherein the external charging coil is usable as a lanyard to suspend the computing apparatus.

3. The computing system of claim 2, wherein the computing apparatus is a wearable electronic device.

4. The computing system of claim 3, wherein the computing apparatus is a badge PC (personal computer).

5. The computing system of claim 4, wherein the computing apparatus is to provide one or more security functions.

6. The computing system of claim 1, wherein the external charging coil includes:
an exterior insulating cover; and
an interior conductor.

7. The computing system of claim 1, wherein the computing apparatus and the external charging coil are permanently coupled together.

8. An external charging coil comprising:
an exterior insulating cover; and
an interior conductor;
wherein the external charging coil is self-coiling, the charging coil to transition to an uncoiled state when the external charging coil is weighted and to transition to a coiled state when the external charging coil is unweighted.

9. The external charging coil of claim 8, wherein the exterior insulating cover comprises PVC (polyvinyl chloride).

10. The external charging coil of claim 8, wherein the interior conductor comprises a copper cable.

11. The external charging coil of claim 8, wherein the external charging coil is operable as an inductive receiving coil when in the coiled state.

12. The external charging coil of claim 8, wherein the external charging coil is operable as a lanyard for support of a device when weighted.

13. The external charging coil of claim 8, further comprising one or more connectors to connect and disconnect the external charging coil.

14. A charging station comprising:
a charging mat portion, the charging mat portion including an inductive transmission coil to generate an electromagnetic field; and
a core coupled with the charging mat portion, the core to provide a charging location for an inductive receiving coil.

15. The charging station of claim 14, wherein the core comprises a solid non-metallic material.

16. The charging station of claim 15, wherein the core is cylindrical in shape at least in part to hang a device including a self-coiling charging coil for charging of the device.

17. The charging station of claim 16, wherein the charging station is a vertical charging station.

18. The charging station of claim 16, further comprising a compressible cover over the core.

19. The charging station of claim 18, wherein the compressible cover is to compress a plurality of coils of the charging coil together for a charging operation in response to the hanging weight of the device on the core.

20. The charging station of claim 18, wherein the compressible cover comprises neoprene material.

21. (canceled)

22. The charging station of claim 15, wherein the core is cone shaped at least in part to place a self-coiling charging coil for charging of a computing device.

23. The charging station of claim 22, wherein the charging station is a horizontal charging station.
